(19) United States
(12) Patent Application Publication
(10) Pub. No.: US 2011/0190129 A1
(43) Pub. Date: Aug. 4, 2011

(54) IMPROVEMENTS IN OR RELATING TO ORGANIC COMPOUNDS

(75) Inventors: Gordon Bell, Berkshire (GB); Clair Louise Harris, Berkshire (GB); Ian David Tovey, Berkshire (GB)

(73) Assignee: SYNGENTA LIMITED, Guildford, Surrey (GB)

(21) Appl. No.: 12/674,727

(22) PCT Filed: Aug. 13, 2008
(86) PCT No.: PCT/GB2008/002730

§ 371 Date: Apr. 18, 2011

(30) Foreign Application Priority Data
Aug. 24, 2007 (GB) 0716592.1

(51) Int. Cl. A01N 25/32; A01N 43/707; A01N 43/56; A01N 43/88; A01N 43/70; A01N 43/54; A01N 43/36; A01N 37/34; A01N 33/24; A01N 37/20; A01P 3/00; A01P 5/00; A01P 7/00; A01P 13/00

(52) U.S. Cl. 504/105; 514/383; 504/139; 514/406; 504/130; 504/133; 514/275; 514/422; 514/525; 514/676; 504/149

(57) ABSTRACT

A composition comprising a compound of formula (I) CH₃CH(OH)C(═O)NR¹R² where R¹ and R² are each independently hydrogen; or C₁₋₆ alkyl, C₂₋₆ alkenyl or C₃₋₆ cycloalkyl, each of which is optionally substituted by up to three substituents independently selected from phenyl, hydroxy, C₁₋₅ alkoxy, morpholinyl and NR³R⁴ where R³ and R⁴ are each independently C₁₋₃ alkyl; or phenyl optionally substituted by up to three substituents independently selected from C₁₋₃ alkyl; or R¹ and R² together with the nitrogen atom to which they are attached form a morpholinyl, pyrrolidinyl, piperidinyl or azepanyl ring, each of which is optionally substituted by up to three substituents independently selected from C₁₋₃ alkyl; and at least one biologically active compound, which comprises at least one aromatic five and/or six membered ring wherein the ring contains at least one nitrogen as a ring member, with the provisos (i) that the composition does not contain cyproconazole when the compound of formula (1) is selected from the group consisting of N-butoxypropyl lactamide; 1-(hydroxyethyl) piperidinyl lactamide; N-methyl-N-propyl lactamide; N-(1-ethylpropyl) lactamide; N,N-dimethyl lactamide; N-1,4-dimethylpentyl lactamide; N-(2-hydroxyethyl)-N-benzyl lactamide; N-Morpholinyl lactamide; N-methyl-N-butyl lactamide; N-Isobutyl lactamide; N-AlIyI lactamide; N-Ethyl lactamide; N-Ethyl-N-(2-hydroxyethyl) lactamide; and N-isopropyl lactamide; and (ii) that the biologically active compound is not nicotinic acid when the compound of formula (1) is diethyl-lactamide. Such compositions may be, or may be comprised by, emulsion concentrates, particularly so in the case that the compound of formula (I) is dimethyl lactamide and the biologically active compound is the fungicide 3-difluoromethyl-1-methyl-1H-pyrazole-4-carboxylic acid(9-isopropyl-1,2,3,4-tetrahydro-1,4-methano-naphthalen-5-yl)-amide shown in FIG. 2.

This invention relates to compositions, particularly for agrochemical use, comprising certain lactamides and biologically active compounds, and to methods of making and using such compositions. In particular the present invention relates to such compositions when formulated as, or comprised by, an emulsion concentrate (EC).

An agrochemical (fungicidal) composition comprising dimethyl lactamide and triforine is disclosed in DE 41 12 873 A1.

Certain lactamides are disclosed in Ratchford, W. P. and Fisher, C. H., Journal of Organic Chemistry, 1950, 15, 317-325; Ratchford, W. P., Journal of Organic Chemistry, 1950, 15, 326-332; Fein, M. L. and Filachione, E. M., Journal of the American Chemical Society, 1953, 75, 2097-2099; and U.S. Pat. No. 4,143,159.

Nowadays, the Formulation Chemist is required to address a number of environmental criteria when developing new formulations. Ideally, a suitable solvent will display many or all of the following properties: an excellent dissolving power for pesticides or other biologically active compounds; made from plant or animal renewable resources; low skin irritation; an ability to reduce the skin irritation associated with aggressive formulation components, such as sodium lauryl sulphate; low ecotoxicity, for example to daphnia; low volatile organic content; and a high flash point. The compositions of the present invention comprise a solvent which displays all or many of these attractive properties.

However, not all solvents are equal with respect to their capacity to dissolve biologically active compounds—the nature of the compound and its interaction with the solvent is substantially decisive. It has surprisingly been found that a particular class of solvent is surprisingly effective in dissolving a particular class of biologically active compound.

According to the present invention there is provided a composition comprising a compound of formula I

CH₃CH(OH)C(═O)NR¹R² (I)

where R¹ and R² are each independently hydrogen; or C₁₋₆ alkyl, C₂₋₆ alkenyl or C₃₋₆ cycloalkyl, each of which is optionally substituted by up to three substituents independently selected from phenyl, hydroxy, C₁₋₅ alkoxy, morpholinyl and NR³R⁴ where R³ and R⁴ are each independently C₁₋₃ alkyl; or phenyl optionally substituted by up to three substituents independently selected from C₁₋₃ alkyl; or R¹ and R² together with the nitrogen atom to which they are attached form a morpholinyl, pyrrolidinyl, piperidinyl or azepanyl ring, each of which is optionally substituted by up to three substituents independently selected from C₁₋₃ alkyl;

and at least one biologically active compound, which comprises at least one aromatic five and/or six membered ring wherein the ring contains at least one nitrogen as a ring member,
with the provisos
(i) that the composition does not contain cyproconazole when the compound of formula 1 is selected from the group consisting of N-butoxypropyl lactamide; 1-(hydroxyethyl)piperidinyl lactamide; N-methyl-N-propyl lactamide; N-(1-ethylpropyl) lactamide; N,N-dimethyl lactamide; N-1,4-dimethylpentyl lactamide; N-(2-hydroxyethyl)-N-benzyl lactamide; N-Morpholinyl lactamide; N-methyl-N-butyl lactamide; N-Isobutyl lactamide; N-Allyl lactamide; N-Ethyl lactamide; N-Ethyl-N-(2-hydroxyethyl) lactamide; and N-isopropyl lactamide; and
(ii) that the biologically active compound is not nicotinic acid when the compound of formula 1 is diethyl-lactamide.

Alkyl groups and moieties are straight or branched chains. Examples are methyl, ethyl, iso-propyl, n-propyl, n-butyl, sec-butyl, tert-butyl, n-amyl and iso-amyl [3-methylbutyl].

Alkenyl groups and moieties may be in the form of straight or branched chains and, where appropriate, may be of either the (E)- or (Z)-configuration. Examples are vinyl and allyl.

Cycloalkyl includes cyclopropyl, cyclopentyl and cyclohexyl.

In one aspect of the composition, in the compound of formula I R¹ and R² are each independently hydrogen; or C₁₋₆ alkyl which is optionally substituted by up to three substituents independently selected from phenyl, hydroxy, C₁₋₅ alkoxy, morpholinyl and NR³R⁴ where R³ and R⁴ are each independently C₁₋₃ alkyl; or R¹ and R² together with the nitrogen atom to which they are attached form a morpholinyl ring which is optionally substituted by up to three substituents independently selected from C₁₋₃ alkyl.

In an even more suitable aspect, R¹ and R² are each independently hydrogen; or C₁₋₆ alkyl; or R¹ and R² together with the nitrogen atom to which they are attached form a morpholinyl ring.

In an even further suitable aspect, R¹ is methyl and R² is methyl, propyl or butyl; or R¹ and R² together with the nitrogen atom to which they are attached form a morpholinyl ring. R³ may be methyl, as may R⁴. For each optional substituent, it is preferred that it is a methyl group. Suitably alkyl groups are branched; most suitably with methyl groups.

The active compound in the composition may be an agrochemical.

In one embodiment of the composition, in the compound of formula 1, R¹ is not hydrogen, methyl, ethyl, propyl, n-butyl, sec-butyl, iso-butyl, n-amyl, iso-amyl, iso-butylenyl, n-hexyl, 1-3-dimethylbutyl, allyl, CH₂CH₂OH, 2-hydroxypropyl, 2-hydroxy-isobutyl, 1,3-dihydroxy-2-methyl-2-propyl, tris-hydroxy-methyl-methyl, CH₂CH₂OCH₃, cyclohexyl, phenyl, benzyl, α-methylbenzyl, β-phenylethyl, 3-hydroxypropyl or 1-hydroxy-2-butyl when R² is hydrogen;

R¹ is not methyl, allyl or phenyl when R² is methyl;
R¹ is not ethyl when R² is ethyl;
R¹ is not n-butyl when R² is n-butyl;
R¹ is not iso-butyl when R² is iso-butyl;
R¹ is not n-amyl when R² is n-amyl;
R¹ is not iso-amyl when R² is iso-amyl;
R¹ is not n-hexyl when R² is n-hexyl;
R¹ is not allyl when R² is allyl;
R¹ is not butyl or phenyl when R² is phenyl;
R¹ is not benzyl when R² is benzyl;
R¹ is not CH₂CH₂OH or ethyl when R² is CH₂CH₂OH;
R¹ is not 2-hydroxypropyl when R² is 2-hydroxypropyl; and
R¹ and R² together with the nitrogen atom to which they are attached do not form a morpholinyl, pyrrolidinyl or piperidinyl unsubstituted ring.

The composition may further comprise a solvent selected from the group consisting of aliphatic solvents; straight or branched chain paraffins; cyclic hydrocarbons; aromatic solvents; phosphorus containing solvents; sulphur containing solvents; nitrogen containing solvents; aliphatic mono, di or triesters; aromatic mono and di esters; cyclic esters; cyclic, aliphatic and aromatic ketones; alkyl cyclohexanones, dialkyl ketones, acetoacetates, benzyl ketones; acetophenone; alcohols; cycloalcohols; glycols; glycol ethers and their polymers; propylene glycols; glycol ether acetates; aromatic alcohols; carbonates; ethers and halogenated solvents.

Particularly preferred further solvents are white oil; decalin; mono, di or tri alkylated benzenes; Solvesso 100 or 200ND (t); triethyl phosphate; tributyl phosphate; tri-2-ethylhexylphosphate; methyl oleate; linoleic acid; linolenic acid; oleic acid; dimethyl decanoamide; tetramethyl sulphone; dimethyl sulphoxide; alkyl ureas; alkanolamines; morpholines; amides; alkyl alkanoates, lactates and acetoacetates; fumarates; succinates; adipates; maleates; glycerol and citric acid esters; alkyl benzoates; benzyl alkanoates; alkyl salicylates; phthalates and dibenzoates; gamma butyrolactone; caprolactone; terpene fenchone; cyclohexanone; alkyl cyclohexanones; 2-ethylhexanol and other alkyl alcohols; cyclohexanol; tetrahydrofurfuryl alcohol; ethylene and propylene glycol and their polymers; dipropylene glycol; monomethyl or monobutyl ether; dipropylene glycol diacetate or other glycol ether acetates, or tripropylene glycol monobutyl ether; benzyl alcohol; propylene or butylene carbonate; dimethyl isosorbide; alkoxyalkanols; diphenyl ether; chlorobenzene and the chloroalkanes.

The biologically active compound may comprise a five membered nitrogen containing aromatic ring which may be selected from the group consisting of pyrrole, pyrazole, imidazole, 1,2,3-triazoles and 1,2,4-triazole, and/or a six membered nitrogen containing aromatic ring which may be selected from the group consisting of pyridine, pyridazine, pyrimidine, pyrazine, 1,2,3-triazine, 1,2,4-triazine and 1,3,5-triazine.

In the case that the compound is an agrochemical it may be selected from the group consisting of insecticides, herbicides, plant growth regulators acaricides, nematicides, miticides, plant activators and fungicides.

The insecticide may be selected from the group consisting of neonicotinoids, bisamides, benzoylureas and carbamates; the herbicide may be selected from the group consisting of triazines and other photosystem 2 inhibitors, 2,6-dinitroanilines, ACCase inhibitors, PPO inhibitors, synthetic auxins, sulphonyl ureas, bipyrillium herbicides, chloroacetanilides, triazolopyrimidines, pyrazoles and herbicidal safeners; the plant growth regulators may be selected from the group consisting of paclobutrazol and maleic hydrazide; and the fungicides may be selected from the group consisting of triazolopyrimidines, pyrimidines, anilinopyrimidines, triazoles and other sterol demethylation inhibitors, MAP kinase inhibitors, strobilurins, adenosine deaminase inhibitors, pyrazoles and carboxamides.

FIG. 1 shows the structure of a particularly preferred fungicidal triazolopyrimidine which may be present in the composition of the invention.

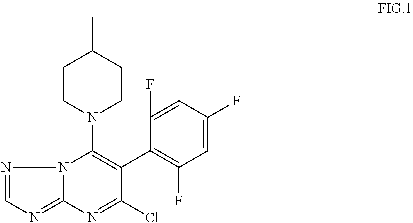

The neonicotinoids may be thiamethoxam and imidacloprid, the bisamide may be rynaxypyr, the benzoylurea may be chlorfluazuron, the carbamate may be pirimicarb; the triazines are atrazine, simazine and cyanazine, the other photosystem 2 inhibitors may be diuron, prometryn and ametryn, the 2,4-dinitroaniline may be fluazinam, the ACC ase inhibitors may be fluazifop-P-butyl and clodinafop propargyl, the PPO inhibitor may be butafenacil, the synthetic auxins may be fluoroxypyr meptyl, the sulfonyl ureas may be nicosulfuron, cinosulfuron, imazosulfuron, primisulfuron methyl, prosulfuron and imazosulfuron, the bipyrillium herbicides may be paraquat and diquat, the chloroacetanilide may be metazachlor, the triazolopyrimidines are cloransulam methyl, florasulam, and penoxsulam, the pyrazole is benzofenap, the herbicidal safener may be cloquintocet, the plant growth regulators may be paclobutrazol and maleic hydrazide; the plant activator is acibenzolar-s-methyl; the pyrimidines may be bupirimate, dimethirimol and ethirimol, the anilinopyrimidines may be cyprodinil and pyrimethanil, the triazoles may be bitertanol, diniconazole, epoxiconazole, fenbuconazole, fluquinconazole, flutriafol, penconazole, tebuconazole, triadimefon, triadimenol, difenoconazole, propiconazole, and hexaconazole, the other sterol demethylation inhibitors are flutriafol, imazalil, and prochloraz, the triazolopyrimidine fungicide may be that shown in FIG. 1, the MAP kinase inhibitor may be fludioxonil, the strobilurins may be azoxystrobin and picoxystrobin, the adenosine deaminase inhibitor may be ethirimol, the pyrazole is bixafen and the carboxamides may be boscalid furametpyr, penthiopyrad, thifluzamide, fluopyram and, in particular, the compound 3-difluoromethyl-1-methyl-1H-pyrazole-4-carboxylic acid(9-isopropyl-1,2,3,4-tetrahydro-1,4-methano-naphthalen-5-yl)-amide, shown in FIG. 2 below.

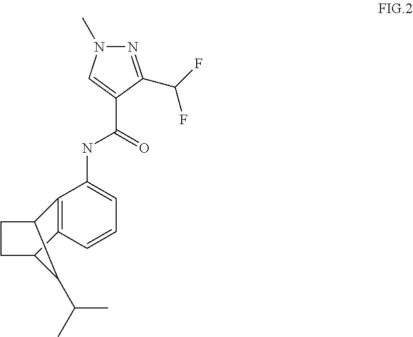

FIG. 3 shows the structure of a further preferred fungicide which may be present in the composition of the invention.

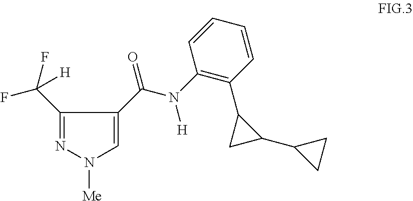

The composition may further comprise at least one compound selected from the group consisting of adjuvants, surfactants, polymers, thickening agents, dyestuffs or pigments, ultraviolet light absorbers, anti bacterial agents, salts, density modifiers, stenching or odour improving agents, taste modifiers, cosolvents, and humectants. The surfactant, may be non-ionic (for example a nonylphenol ethoxylate or an alcohol ethoxylate), anionic (for example an alkyl sulphate, such as sodium lauryl sulphate, or a sulphonate, such as calcium dodecylbenzene sulphonate) or cationic (for example a tertiary amine).

The compound of formula 1 may be present in the composition in an amount of from 0.1 to 99% by weight of the composition and the biologically active compound, which is preferably an agrochemical, may be present in an amount of 0.1 to 75%, likewise by weight.

In a preferred embodiment of the composition, the compound of formula 1 may be present in an amount of from 0.1 to 99% by weight of the composition, the agrochemical may be present in an amount of 0.1 to 75%, by weight and the solvent may be present in an amount of 0.1 to 90%, likewise by weight.

The ratio of compound of formula 1 to agrochemical to solvent may be varied according to needs, a ratio of 1:1:1 or near to these limits is likely to be valuable for many of the desired formulations however the limits on each component could be as low as 0.01:1 for the ratio of any two parts of the formulation.

The lactamide component of the present compositions may be prepared by reacting a compound of formula (III) [CH₃CH(OH)C(═O)OR⁵ (III)] where OR⁵ is a leaving group, with a compound of formula (II) [HNR¹R² (II)] where R¹ and R² are as defined above. R⁵ may be C₁₋₄ alkyl. This process produces HOR⁵ as a by-product; a cleaner reaction avoids this by-product: the lactamide component of the composition of the present invention may also be prepared by reacting lactide [3,6-dimethyl-[1,4]-dioxane-2,5-dione] with a compound of formula (II) [HNR¹R² (II)] where R¹ and R² are as defined above. Schematically, such a reaction is shown below:

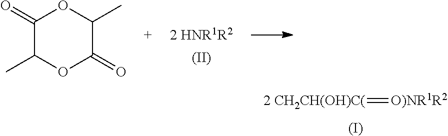

The synthesis is not limited to the above reaction scheme; it illustrates how lactide [3,6-dimethyl-[1,4]-dioxane-2,5-dione] may be converted to a lactamide by reacting lactide with an amine [suitably a primary or secondary amine] which may be carried out under “solvent-free” conditions as the skilled artisan will appreciate.

In a particularly preferred embodiment of the present inventive composition, the ratio of compound of formula 1 to agrochemical to solvent is 1:1:1 or 2:1:1 or 2:1:2 or 3:1:1 or 3:1:2 or 4.5:1:4.5 or 6:1:3 and in a still more preferred embodiment, the compound of formula 1 is dimethyl lactamide (DML) and the agrochemical is the compound 3-difluoromethyl-1-methyl-1H-pyrazole-4-carboxylic acid(9-isopropyl-1,2,3,4-tetrahydro-1,4-methano-naphthalen-5-yl)-amide shown in FIG. 2.

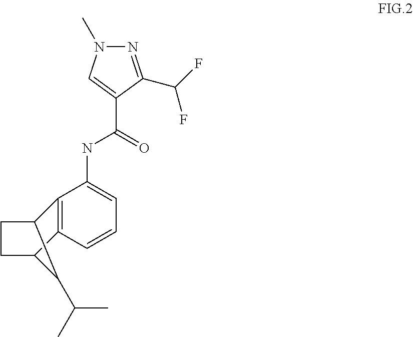

Specific embodiments of the present composition comprise 5 to 95% DML, 0.5 to 50% of the FIG. 2 compound and 5 to 95% of a further solvent selected from the group consisting of Solvesso 200ND, dipropylene glycol monobutyl ether, dipropylene glycol diacetate, methyl benzoate, benzyl benzoate, dimethyl decanoamide, dipropylene glycol monomethyl ether and butyl benzoate.

The skilled man will recognise that the present compositions may be formulated as emulsion concentrates, emulsions in water or oil, microencapsulated formulations, aerosol sprays or fogging formulations; and these may be further formulated into granular materials or powders, for example for dry application or as water-dispersible formulations. The solutions so formed may also be used directly on soil or plants or in other, non-agrochemical, applications.

The particularly preferred formulated form of the composition is as an emulsion concentrate (EC).

The low toxicity of the components of the composition, other than the biologically active compound in the case that it is a pesticide, makes the composition particularly suitable for inclusion in, or formulation as, skin creams, lotions, sun creams, personal hygiene products and pharmaceutical formulations, such as tablets, suppositories, inhalers, dermal creams and potions, depending on the nature of the pharmaceutically or cosmetically active ingredient.

The present inventive compositions have a low toxicity and excellent environmental profile meaning that they are particularly useful in applications where the minimisation of pollution is desired. Examples of such applications include paper making, water treatment, forestry applications, public health treatments, use in municipal pools and other water courses, in applications near rivers, lakes, reservoirs or seas and in applications where release to the atmosphere has to be minimised or controlled and where damage to the atmosphere is not desirable. Examples include use of fungicide containing compositions according to the present invention in exterior and interior paints, coatings, varnishes, waxes or other protectant layers or opacifiers, colourants or screens; in dyeing, pigmentation or the use of inks; in cleaning products designed for the home, garden or industrial applications; and in soap or detergent applications for industrial, home or environmental usage. The compositions of the present invention may also be used in shampoos, and in household detergents and household cleaners (for example surface cleaners), in which the active ingredient may be a fungicide (possibly azoxystrobin) in the case of shampoo or a bacteriocide in the case of the detergents and cleaners.

The present invention also provides a method of making the inventive composition disclosed above by admixing a compound of formula 1 as indicated above with a biologically active compound.

The present invention also provides a method of controlling an agricultural pest comprising application to the pest or to a surface on which it is capable of being present of an pesticidally effective amount of a composition according to the invention. The pest may be a fungus and the agrochemical may be a fungicide, in particular 3-di fluoromethyl-1-methyl-1H-pyrazole-4-carboxylic acid(9-isopropyl-1,2,3,4-tetrahydro-1,4-methano-naphthalen-5-yl)-amide (FIG. 2 above) or the fungicide shown in FIG. 3.

The invention still further provides the use of the present inventive composition to control a plant pest. In a particularly preferred use, the pest is a phytopathogenic fungus, the compound of formula 1 is dimethyl lactamide, the agrochemical has the structure 3-difluoromethyl-1-methyl-1H-pyrazole-4-carboxylic acid(9-isopropyl-1,2,3,4-tetrahydro-1,4-methano-naphthalen-5-yl)-amide (FIG. 2) and the composition comprises a further solvent selected from the group consisting of Solvesso 200ND, dipropylene glycol monobutyl ether or dipropylene glycol diacetate, methyl benzoate, benzyl benzoate, dimethyl decanoamide, dipropylene glycol monomethyl ether and butyl benzoate.

The compositions of the present invention are particularly valuable in formulations where contact with either human or animal skin or eyes is required or may occur by accident. Applications such as the use of shampoo or body cleaning fluids (such as shower gels, hand or body wipes and medical wipes) may benefit from the safe nature of these lactamide solvent present in the composition, which may form part of a cleaning formulation and which may also reduce the irritancy of some of the other ingredients, such as surfactants. In a similar fashion the irritation to skin or eyes caused by the direct application of pharmaceutical or veterinary compositions to them may be reduced relative to the like application of prior art compositions containing the same pharmaceutically active ingredients. The compositions of the present invention may also be used for anti-bacterial purposes. Hand cleansers and fluids used to clean floors, kitchens or vehicles may also benefit from the inherent reduction in risk associated with the safening nature of the lactamide solvent.

The invention is illustrated by the following non limiting Examples.

### EXAMPLE 1

The following general method is used to measure the solubility of pesticide samples in solvents. A 2 ml aliquot of solvent is added to a 5 ml volume glass vial. Pesticide is added such that half of the volume of the liquid is filled. The sample is shaken for one minute and left to stand for 24 hours. Samples which have dissolved are refilled with more of the pesticide, shaken and left for a further 24 hours. This process is continued until the samples have equilibrated for three days without the need for further pesticide addition. The samples are then placed in a temperature controlled oven at 25 C for one week prior to analysis by high pressure liquid chromatography. All samples are filtered and centrifuged prior to chromatographic analysis.

Two common solvents used in the pesticide industry are Solvesso 200 and acetophenone. They have been used to manufacture many commercial emulsion concentrate formulations. As a comparison the solubility of fludioxynil, hexaconazole, 3-di fluoromethyl-1-methyl-1H-pyrazole-4-carboxylic acid(9-isopropyl-1,2,3,4-tetrahydro-1,4-methano-naphthalen-5-yl)-amide (FIG. 2), prometryn, thiamethoxam and cyprodinil, have been compared in these two solvents to dimethyl lactamide. All of these compounds contain either five or six membered aromatic heterocyclic rings. In each case the solubility in dimethyl lactamide is better than in ether Solvesso 200ND or acetophenone.

TABLE 1

| | Fludioxynil | Diuron | Hexa- | Compound of | | Epoxi- | | | | |
|---|---|---|---|---|---|---|---|---|---|---|
| Solvent | % w/w | % w/w | conazole | FIG. 2 | Prometryn | conazole | Thiamethoxam | Cyprodinil | Rynaxypry | Ametryn |
| Dimethyl | 30.1 | 11.0 | 18 | 32.1 | 43 | 8.0 | 9.0 | 65.0 | 2.8 | 53.0 |
| lactamide | | | | | | | | | | |
| Acetophenone | 8.5 | 4.8 | 11.7 | 14.1 | 19 | NA | 5.0 | 47.7 | 0.75 | 47.4 |
| Solvesso | 0.3 | <0.2* | 4.4 | 5.6 | 12 | 2.5 | 0.2 | 36.0 | 0.06 | 29.3 |
| 200ND | | | | | | | | | | |

*Analysis by chromatography was not available for this sample. Diuron was not soluble at 0.2% w/w.

### EXAMPLE 2

The compounds chlorothalonil, tralkoxydim and napropamide have chemical structures which do not contain aromatic heterocyclic rings. Table 2 displays the solubility of the three solvents dimethyl lactamide, Solvesso 200ND and acetophenone. In each case the solubility of the compounds in dimethyl lactamide is lower than that for the other two solvents.

TABLE 2

| Solvent | Chlorothalonil | Tralkoxydim | Napropamide |
|---|---|---|---|
| Dimethyl lactamide | 1.6 | 3.2 | 19.2 |
| Acetophenone | 5.4 | 12.7 | 27.6 |
| Solvesso 200ND | 8.3 | N/A | 20.7 |

1. A composition comprising a compound of formula I
CH₃CH(OH)C(═O)NR¹R² (I)
where R¹ and R² are each independently hydrogen; or C₁₋₆ alkyl, C₂₋₆ alkenyl or C₃₋₆ cycloalkyl, each of which is optionally substituted by up to three substituents independently selected from phenyl, hydroxy, C₁₋₆ alkoxy, morpholinyl and NR³R⁴ where R³ and R⁴ are each independently C₁₋₃ alkyl; or phenyl optionally substituted by up to three substituents independently selected from C₁₋₃ alkyl; or
R¹ and R² together with the nitrogen atom to which they are attached form a morpholinyl, pyrrolidinyl, piperidinyl or azepanyl ring, each of which is optionally substituted by up to three substituents independently selected from C₁₋₃ alkyl;
and at least one biologically active compound, which comprises at least one aromatic five and/or six membered ring wherein the ring contains at least one nitrogen as a ring member,
with the provisos
(i) that the composition does not contain cyproconazole when the compound of formula 1 is selected from the group consisting of N-butoxypropyl lactamide; 1-(hydroxyethyl)piperidinyl lactamide; N-methyl-N-propyl lactamide; N-(1-ethylpropyl) lactamide; N,N-dimethyl lactamide; N-1,4-dimethylpentyl lactamide; N-(2-hydroxyethyl)-N-benzyl lactamide; N-Morpholinyl lactamide; N-methyl-N-butyl lactamide; N-Isobutyl lactamide; N-Allyl lactamide; N-Ethyl lactamide; N-Ethyl-N-(2-hydroxyethyl) lactamide; and N-isopropyl lactamide; and
(ii) that the biologically active compound is not nicotinic acid when the compound of formula 1 is diethyl-lactamide.

2. A composition according to claim 1, wherein the active compound is an agrochemical.

3. A composition according to claim 1, wherein in the compound of formula 1 R¹ is not hydrogen, methyl, ethyl, propyl, n-butyl, sec-butyl, iso-butyl, n-amyl, iso-amyl, iso-butylenyl, n-hexyl, 1-3-dimethylbutyl, allyl, CH₂CH₂OH, 2-hydroxypropyl, 2-hydroxy-isobutyl, 1,3-dihydroxy-2-methyl-2-propyl, tris-hydroxy-methyl-methyl, CH₂CH₂OCH₃, cyclohexyl, phenyl, benzyl, α-methylbenzyl, 6-phenylethyl, 3-hydroxypropyl or 1-hydroxy-2-butyl when R² is hydrogen;
R¹ is not methyl, allyl or phenyl when R² is methyl;
R¹ is not ethyl when R² is ethyl;
R¹ is not n-butyl when R² is n-butyl;
R¹ is not iso-butyl when R² is iso-butyl;
R¹ is not n-amyl when R² is n-amyl;
R¹ is not iso-amyl when R² is iso-amyl;
R¹ is not n-hexyl when R² is n-hexyl;
R¹ is not allyl when R² is allyl;
R¹ is not butyl or phenyl when R² is phenyl;
R¹ is not benzyl when R² is benzyl;
R¹ is not CH₂CH₂OH or ethyl when R² is CH₂CH₂OH;
R¹ is not 2-hydroxypropyl when R² is 2-hydroxypropyl; and
R¹ and R² together with the nitrogen atom to which they are attached do not form a morpholinyl, pyrrolidinyl or piperidinyl unsubstituted ring.

4. A composition according to claim 1, which further comprises a solvent selected from the group consisting of aliphatic solvents; straight or branched chain paraffins; cyclic hydrocarbons; aromatic solvents; phosphorus containing solvents; sulphur containing solvents; nitrogen containing solvents; aliphatic mono, di or triesters; aromatic mono and di esters; cyclic esters; cyclic, aliphatic and aromatic ketones; alkyl cyclohexanones, dialkyl ketones, acetoacetates, benzyl ketones; acetophenone; alkyl alcohols; cycloalcohols; glycols; glycol ethers and their polymers; propylene glycols; glycol ether acetates; aromatic alcohols; carbonates; ethers and halogenated solvents.

5. A composition according to claim 4, wherein the solvent is selected from the group consisting of white oil; decalin; mono, di or tri alkylated benzenes; Solvesso 100 or 200ND (t); triethyl phosphate, tributyl phosphate or tris-2-ethylhexylphosphate; methyl oleate; linoleic acid; linolenic acid; oleic acid; dimethyl decanoamide; tetramethyl sulphone; dimethyl sulphoxide; alkyl ureas; alkanolamines; morpholines; amides; alkyl alkanoates, lactates and acetoacetates; fumarates; succinates; adipates; maleates; glycerol and citric acid esters; alkyl benzoates; benzyl alkanoates; alkyl salicylates; phthalates and dibenzoates; gamma butyrolactone; caprolactone; terpene fenchone; cyclohexanone; alkyl cyclohexanones; 2-ethylhexanol; cyclohexanol; tetrahydrofurfuryl alcohol; ethylene and propylene glycol and their polymers; dipropylene glycol; monomethyl or monobutyl ether; dipropylene glycol diacetate, or tripropylene glycol monobutyl ether; benzyl alcohol; propylene or butylene carbonate; dimethyl isosorbide; alkoxyalkanols; diphenyl ether; chlorobenzene and chloroalkanes.

6. A composition according to claim 1, wherein the five membered nitrogen containing aromatic ring is selected from the group consisting of pyrrole, pyrazole, imidazole, 1,2,3-triazoles and 1,2,4-triazole.

7. A composition according to claim 1, wherein the six membered nitrogen containing aromatic ring is selected from the group consisting of pyridine, pyridazine, pyrimidine, pyrazine, 1,2,3-triazine, 1,2,4-triazine and 1,3,5-triazine.

8. A composition according to claim 1, wherein the agrochemical is selected from the group consisting of insecticides, herbicides, plant growth regulators, plant activators, acaricides, nematicides, miticides and fungicides.

9. A composition according to claim 8, wherein the insecticide is selected from the group consisting of neonicotinoids, bisamides, benzoylureas and carbamates; the herbicide is selected from the group consisting of triazines and other photosystem 2 inhibitors, 2,6-dinitroanilines, ACCase inhibitors, PPO inhibitors, synthetic auxins, sulphonyl ureas, bipyrillium herbicides, chloroacetanilides, triazolopyrimidines, pyrazoles and herbicidal safeners; the plant growth regulators are selected from the group consisting of paclobutrazol and maleic hydrazide; and the fungicides are selected from the group consisting of pyrimidines, anilinopyrimidines, triazoles and other sterol demethylation inhibitors, triazolopyrimidines MAP kinase inhibitors, strobilurins, adenosine deaminase inhibitors, pyrazoles and carboxamides.

10. A composition according to claim 1, wherein neonicotinoids are thiamethoxam and imidacloprid, the bisamide is rynaxypyr, the benzoylurea is chlorfluazuron, the carbamate is pirimicarb; the triazines are atrazine, simazine and cyanazine, the other photosystem 2 inhibitors are diuron, prometryn and ametryn, the 2,4-dinitroaniline is fluazinam, the ACC ase inhibitors are fluazifop-P-butyl and clodinafop propargyl, the PPO inhibitor is butafenacil, the synthetic auxins are fluoroxypyr meptyl, the sulfonyl ureas are nicosulfuron, cinosulfuron, imazosulfuron, primisulfuron methyl, prosulfuron and imazosulfuron, the bipyrillium herbicides are paraquat and diquat, the chloroacetanilide is metazachlor, the triazolopyrimidines are cloransulam methyl, florasulam, and penoxsulam, the pyrazole is benzofenap, the herbicidal safener is cloquintocet, the plant growth regulators are paclobutrazol and maleic hydrazide; the plant activator is acibenzolar-s-methyl the pyrimidines are bupirimate, dimethirimol and ethirimol, the anilinopyrimidines are cyprodinil and pyrimethanil, the triazolopyrimidine fungicide has the structure shown in FIG. 1, the triazoles are bitertanol, diniconazole, epoxiconazole, fenbuconazole, fluquinconazole, flutriafol, penconazole, tebuconazole, triadimefon, triadimenol, difenoconazole, propiconazole, and hexaconazole, the other sterol demethylation inhibitors are flutriafol, imazalil, and prochloraz, the MAP kinase inhibitor is fludioxonil, the strobilurins are azoxystrobin and picoxystrobin, the adenosine deaminase inhibitor is ethirimol, the pyrazole is bixafen and the carboxamides are boscalid furametpyr, penthiopyrad, thifluzamide, fluopyram and the compound 3-difluoromethyl-1-methyl-1H-pyrazole-4-carboxylic acid(9-isopropyl-1,2,3,4-tetrahydro-1,4-methano-naphthalen-5-yl)-amide, as shown in FIG. 2.

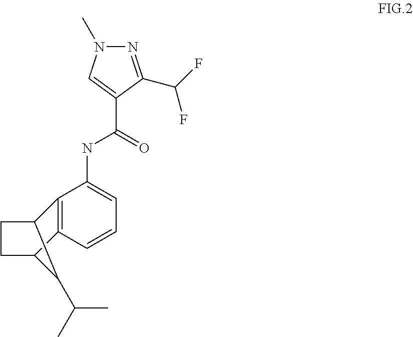

11. A composition according to claim 1, which further comprises at least one compound selected from the group consisting of adjuvants, surfactants, polymers, thickening agents, dyestuffs or pigments, ultraviolet light absorbers, anti bacterial agents, salts, density modifiers, stenching or odour improving agents, taste modifiers, cosolvents, and humectants.

12. A composition according to claim 1, wherein the compound of formula 1 is present in an amount of from 0.1 to 99% by weight of the composition and the agrochemical is present in an amount of 0.1 to 75%, likewise by weight.

13. A composition according to claim 2, wherein the compound of formula 1 is present in an amount of from 0.1 to 99% by weight of the composition, the agrochemical is present in an amount of 0.1 to 75%, by weight and the solvent is present in an amount of 0.1 to 90%, likewise by weight.

14. A composition according to claim 13, wherein the ratio of compound of formula 1 to agrochemical to solvent is defined within the limits 0.01 to 1:0.01 to 1:0.01 to 1.

15. A composition according to claim 13, wherein the ratio of compound of formula 1 to agrochemical to solvent is 1:1:1 or 2:1:1 or 2:1:2 or 3:1:1 or 3:1:2 or 4.5:1:4.5 or 6:1:3.

16. A composition according to claim 1, wherein the compound of formula 1 is dimethyl lactamide and the agrochemical is 3-difluoromethyl-1-methyl-1H-pyrazole-4-carboxylic acid(9-isopropyl-1,2,3,4-tetrahydro-1,4-methano-naphthalen-5-yl)-amide (shown in FIG. 2).

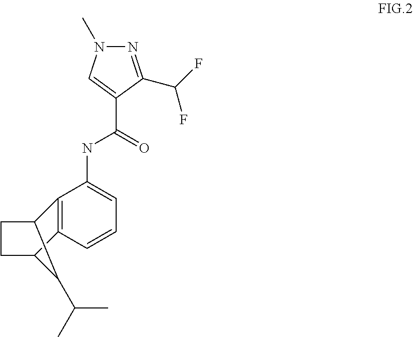

17. A composition according to claim 16, comprising 5 to 95% DML, 0.5 to 50% 3-difluoromethyl-1-methyl-1H-pyrazole-4-carboxylic acid(9-isopropyl-1,2,3,4-tetrahydro-1,4-methano-naphthalen-5-yl)-amide (FIG. 2) and 5 to 95% solvent selected from the group consisting of the solvents of claim 4.

18. A composition according to claim 17, wherein the solvent is selected from the group consisting of Solvesso 200ND, dipropylene glycol monobutyl ether, dipropylene glycol diacetate, methyl benzoate, benzyl benzoate, dimethyl decanoamide, dipropylene glycol monomethyl ether and butyl benzoate.

19. A composition according to claim 1, when formulated as an emulsion concentrate (EC).

20. A method of making a composition according to claim 1, comprising admixing a compound of formula 1 according to claim 1 with an biologically active agent according to claim 1.

21. A method of controlling an agricultural pest comprising application to the pest or to a surface on which it is capable of being present of a pesticidally effective amount of a composition according to claim 1.

22. A method according to claim 21, wherein the pest is a fungus and the agrochemical is a fungicide.

23. A method according to claim 22, wherein the fungicide has the structure shown in FIG. 2 (3-difluoromethyl-1-methyl-1H-pyrazole-4-carboxylic acid(9-isopropyl-1,2,3,4-tetrahydro-1,4-methano-naphthalen-5-yl)-amide)

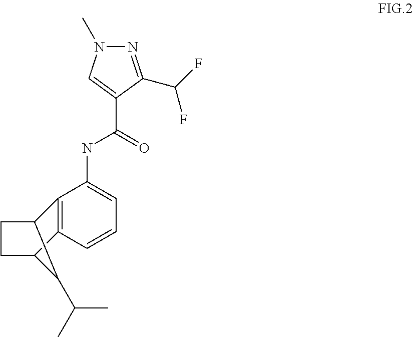

24. (canceled)

25. (canceled)
